(19) United States
(12) Patent Application Publication
(10) Pub. No.: US 2020/0406563 A1
(43) Pub. Date: Dec. 31, 2020

(54) METHOD AND PROCESS TO PRODUCE ADVANCED THEROMOPLASTIC BASED COMPOSITE MATERIAL PARTS

(71) Applicants: MIGUEL ANGEL ALCANTARA, Queretaro (MX); MIGUEL ANGEL ALCANTARA, Queretaro (MX); ORBY ROTOMOLDEO SA DE CV, Queretaro (MX); CIDESI CENTRO DE INGENIERIA Y DESARROLLO INDUSTRIAL, Queretaro (MX)

(72) Inventors: MIGUEL ANGEL ALCANTARA, QUERETARO (MX); MIGUEL ANGEL ALCANTARA-PELAYO, QUERETARO (MX); EDGAR ADRIAN FRANCO - URQUIZA, QUERETARO (MX)

(73) Assignees: ORBY ROTOMOLDEO S.A. DE C.V., Queretaro (MX); CIDESI - CENTRO DE INGENIERIA Y DESARROLLO INDUSTRIAL, Queretaro (MX)

(21) Appl. No.: 16/453,026

(22) Filed: Jun. 26, 2019

(51) Int. Cl. B29C 70/34; B29B 11/06; B29C 70/86

(52) U.S. Cl. CPC B29C 70/342; B29K 2101/12; B29C 70/86; B29B 11/06

(57) ABSTRACT

The present invention relates to a novel fiber-reinforced thermoplastic composite material and a method and apparatus for producing thereof. The fiber reinforced thermoplastic composite material is advantageously used in many fields of applications such as aircraft, aerospace plane, automobile, vessel, construction and civil engineering materials, electronic device, furniture pieces or leisure parts and sporting goods or parts of it.

### BACKGROUND OF THE INVENTION

### Field of the Invention

The present invention relates to a novel fiber-reinforced thermoplastic composite material and method and process to produce it. The fiber reinforced thermoplastic composite material is advantageously used in many fields of applications such as aircraft, aerospace planes, automobiles, ships, construction and civil engineering materials, electronic devices, furniture pieces, leisure parts and sporting goods.

The present invention provides fiber reinforced thermoplastic composite materials, a relatively new type of material with special characteristics, properties and a versatile range of possible applications. Thermoplastic composite materials provide certain important advantages over other types of composites, metals, and certain materials for goods manufacturing.

Thermoplastic polymers differ from elastomer or thermoset plastics because of an ability to be softened or fully melted and reshaped upon heating, while remaining chemically and dimensionally stable over a wide range of operational temperatures and pressures. Together with the availability of tailored physical chemistry properties, this characteristic makes thermoplastics highly adaptable for use as substrates for microfluidic applications, a principle that is exploited, as will be shown, in the case of the present invention.

Currently, composite materials that have demonstrated successful results in aircraft, automotive, and a range of other uses are fiber reinforced resin matrix. The fibers include carbon fibers, silica fibers, glass fibers, E type glass, boron fibers, boron carbide, boron carbonitride, fibers based on metal oxides, natural fibers, flax, hemp and sisal fibers, metallized carbon fibers and metallized glass fibers, colored fibers and mixtures thereof. These fibers perform a reinforcing function within a thermoplastic or a thermoset matrix. Thermoset composites have dominated the market because of their properties and advantages including their high strength and stiffness, higher temperature applications, lower shrinkage, and in some cases, ease of lamination in laying up composite layers. Nevertheless, thermoplastic composites have increased their presence in the market of polymer based structural composites due to relevant specific properties that are an improvement over thermoset composites for many applications, including higher toughness, high impact strength, higher production rate, low environmental impact (recyclable), good surface finishing, and more cost effective. The predominant processes for producing thermoplastics parts are injection molding, compression molding, roto-molding, and to some extent for the case of thermoplastic containing composites, autoclave prepreg layup process, prepreg or resin pre-impregnated fiber in form of fabric or cloth or long fiber tape prepared by dry or wet procedures; this processes involve thermoplastic prepreg tape winding, in which thermoplastic prepreg tape is wound over the mandrel or mold shape applying heat and pressure at the contact point for melting and consolidation of the thermoplastic tape in a single step.

Commonly used reinforcing fibers are mainly made of carbon, glass and aramid. Resins such as polyetherketone (PEEK), polyphenylene sulfide (PPS), polyamide (NYLON), polyetherimide (PEI), polypropylene (PP) are used for tape winding. The thermoplastic tape wound process mandrel requires heating means to control the thermic profile. Therefore, unexpected properties and crystallinity of the composite result. Resistance in mandrel or roller are used. Heating from the top causes problems because sticking of the tape is a practical handicap in tape winding. Problems with tape wound are heat rate application, speed and force from the roller, which require stringent process control requirements. For example, a common problem is localized melting areas for which press or autoclave processes are required to correct the problem.

Another process for thermoplastic composite manufacture is thermoforming. Thermoforming is a process in which a blank is heated close to the melting temperature of the resin matrix and then transferring the blank to a final form press die. A part must be kept under pressure until it reaches the glass transition temperature to avoid shape distortion. Heating mechanisms include infra-red heating, conventional ovens, and using a heated platen press. Heating normally presents problems with gradient control, lack of uniformity in certain shapes and overheating spots. Thermoforming implies different polymer flow mechanisms and fiber distribution control requirements. Polymer percolation and squeeze flow need careful control and in parallel, fiber interplay and intraplay, which imply the interlayer shifting or overlapping or mold layer interphase displacement, must be carefully controlled during forming to avoid breaking or buckling of the fiber to properly form the part.

The aforementioned problem is derived from processing complex shapes that during thermoforming, resin flow and shear stress on plays provoke buckles by the extension derived from the tension during pressing in pronounced curves or vertical areas of the mold.

Thermoplastic composites production is solely a physical process because no chemical reaction takes place during heating. Thermosets differ, in which thermal curing involves chemical reactions. This is important in the context of the present invention, because the focus of the proposed procedure involves only physical changes during heating.

Composite materials have well-known advantages over traditional construction materials. More particularly, they provide excellent mechanical properties at very low material densities. As a result, the use of such materials is becoming increasingly widespread in fields of application such as industrial, sports, leisure, automotive and high performance aerospace components. Although these cured materials clearly have a number of benefits, it has long been known that they can suffer from poor impact resistance and be prone to delamination. This is particularly the case when epoxy resin systems are used, which are known to tend to produce cured systems with low toughness.

Most of the composites for use in aerospace applications must meet exacting standards on mechanical properties.

The present invention provides improvements over the above described problems and/or provides unexpected properties.

### DESCRIPTION OF RELATED ART

A wide range of techniques and methods fiber—thermoplastic and thermoset composites manufacture have been suggested in the prior art. For example, Jessrang, U.S. Pat. No. 10,029,426 is directed to a device for producing a fiber-reinforced thermoplastic composite component.

Jevons, U.S. Pat. No. 9,638,043 IS directed to a method of manufacturing a composite material including a thermoplastic coated reinforcing element.

Bartel et al., U.S. Pat. No. 9,498,915 is directed to fabrication of reinforced thermoplastic composite parts.

Haverty et al. U.S. Pat. No. 8,652,290 is directed to systems and methods for manufacturing composite materials using thermoplastic polymers.

Duqueine et al., U.S. Pat. No. 8,066,927 is directed to a method for making a thermoplastic composite part by molding.

Rubin et al. U.S. Pat. No. 7,807,005 is directed to a fabrication process for thermoplastic composite parts.

Tilbrook et al., U.S. Pat. No. 7,754,322 is directed to composite materials possessing a blend of thermoplastic particles.

Edwards et al., U.S. Pat. No. 6,824,860 is directed to a thermoplastic composite reinforced thermoform and blow-molded article.

Montsinger et al., U.S. Pat. No. 6,604,927 is directed to an apparatus for forming thermoplastic composite materials. Montsinger et al., U.S. Pat. No. 6,258,453 is directed to thermoplastic composite materials made by rotational shear.

Murphy et al., U.S. Pat. No. 6,190,598 is directed to a method for making thermoplastic composite pressure vessels.

Kruse et al., US20050258575 is directed to a non-isothermal method for fabricating hollow composite parts.

Sargent, U.S. Pat. No. 5,401,154 is directed to an apparatus for compounding a fiber reinforced thermoplastic material and forming parts therefrom.

Goldsworthy, U.S. Pat. No. 4,469,541 is directed to a method for forming reinforced plastic composite articles.

Ganga, U.S. Pat. No. 4,614,678 is directed to a flexible composite material and process for producing same.

Benson et al., U.S. Pat. No. 9,527,237 is directed to an induction heating compaction system.

Kaiser et al., U.S. Pat. No. 6,485,660 (Marshall Industries Composites, Inc.) is directed to a reinforced composite product and apparatus and a method for producing same.

Lindenmayer et al., U.S. Pat. No. 441,047 (Klockner-Werke A.G.) is directed to a method for making two moldings and combining them to make a composite product.

Simmons et al., U.S. Pat. No. 9,868,265 is directed to a structured thermoplastic with composite interleaves.

Jevons et al., U.S. Pat. No. 9,638,043 is directed to a method of manufacturing a composite material including a thermoplastic coated reinforcing element.

Bartel et al., U.S. Pat. No. 9,498,915 is directed to the fabrication of reinforced thermoplastic composite parts.

Haverty et al., U.S. Pat. No. 8,652,290 is directed to systems and methods for manufacturing composite materials using thermoplastic polymers.

### SUMMARY OF THE INVENTION

The present invention comprises a method of producing a fiber reinforced thermoplastic composite part or complex component thereof, comprising the steps of laying one or a plurality of elements comprising reinforcing fibers cloth layers or any other reinforcing material fabric onto a surface of a hollow or not hollow part of a thermoplastic polymeric material wherein the thermoplastic polymeric material preferably comprising a prefabricated or preformed shape preferably prepared within a mold by a roto-molding thermal process, using the roto-molding or shape mold, taking back and accommodating the part or component comprising the reinforced material surface layers to fit within the mold or initial forming shape interior; compressing a polymeric part wall and reinforcing fiber cloth against a mold wall inside the mold using pressurized gas from the internal space of hollow piece, rising in parallel its temperature to obtain a viscoelastic condition or near melting condition of the polymer to achieve a compressed contact between the reinforcing fiber or pre-impregnated reinforcing fiber, creating a single monolithic material composite with a thermoplastic polymer piece and comprising multi-ply layers integrated to the original polymeric resin by a fusion bonding and microfluidics mechanism between fiber cloth and polymer piece, conducting the production of thermoplastic composite material under pressure against the mold wall controlling temperature, viscoelastic condition and cooling rate, optionally, laying fiber reinforcing material onto the interior surface of the mold to create an intimate contact and inter-diffusion between the thermoplastic polymeric part surface and the mold wall and maintaining in a sandwich arrangement, the reinforced material cloth at viscoelastic temperature to form high properties thermoplastic composite material.

The present invention further comprises reinforcing fibers selected from a group including but not limited to a thermoplastic polymer fabric impregnated or not impregnated or any reinforcing resin pre-impregnated fiber (prepreg fiber).

The present invention further comprises a method wherein producing the process for preparing thermoplastic basic polymer preshape-reinforcing fiber composite material comprises a thermal forming process, roto-molding, injection molding, compression molding and an autoclave prepreg layup process wherein the mold produces any shape.

The present invention further comprises a method comprising the steps of initially accommodating the reinforcing fiber cloth or laying up on to the mold internal surface, taking the fabricated polymeric part and positioning and fitting it in the mold interior wall and forming a sandwich arrangement conformed by the polymeric part wherein the reinforcing fiber cloth and the mold wall forms the thermoplastic composite material that comprises the polymeric part and the integrated reinforced fiber cloth for conforming the composite material part.

The present invention further comprises a method wherein the laying up reinforced fiber cloth comprises one or more layers of the reinforcing fabric or fiber forms the composite material.

The present invention further comprises a method further comprising the steps of winding thermoplastic prepreg or not prepreg tape over a previous polymer part or shape, locally applying heat and pressure at a contact point, and melting and consolidating the thermoplastic tape over the entire surface of the part in a single step.

The present invention further comprises a method wherein the compression of the layers comprising the composite material against the mold wall occurs by a method comprising the pressure produced by pressurized gas inside the hollow piece to compress the piece wall and layer or layers set against the mold wall.

The present invention further comprises a method wherein the composite material compression of reinforced fiber layers and polymer piece against the mold wall comprises method assisted by generating a low pressure atmosphere in a space formed between the polymeric piece and mold in order evacuate possible residual air or other gas bubbles gaps left trapped in this space, contained in the fiber cloth. The present invention further comprises a method comprising improving significant mechanical properties for the whole composite by eliminating discontinuities, air gaps, or bubbles contained in the space under vacuum condition.

The present invention further comprises a method further comprising employing low pressure to evacuate and eliminate trapped gases in the reinforced fiber cloth space between mold wall and the polymer piece wall. The present invention further comprises a method comprising conducting low pressure by the action of vacuum provided through ports disposed in the mold wall and distributed to achieve a uniform vacuum condition by the suction action in the space.

The present invention comprises a method of compressing the composite material layers wherein heat energy is transferred to the composite piece to raise its temperature up to the piece's viscoelastic condition wherein the compression depends on the resin thermal characteristics in which the fiber is embedded and pre-shape piece polymer characteristics in order to achieve the proper consolidation in accordance to resin requirements and wherein heating is conducted from the exterior or from the interior of the piece or mold by a heat source.

The present invention further comprises a method wherein the pressure gas access port is positioned in any location and position to supply uniform pressurized gas to the internal space of the mold and wherein low pressure or vacuum produced in the space between polymer piece and metal mold is produced by external nozzles connected to vacuum hoses disposed on the external mold surface.

The present invention further comprises a method comprising fabricating thermoplastic composite high pressure vessels and laying up additional reinforcing fiber cloth on to the initial polymer piece and wrapping high resistance polymer tape to the external surface of the polymer part.

The present invention further comprises a method wherein the polymer preformed part comprises reinforcing particulates or reinforcing fibers in order to increase the mechanical properties of such preshaped original part and therefore the properties of the whole composite fabricated part.

The present invention further comprises a method comprising incorporating an internal layer of a second reinforced polymer as an added layer on to the surface of the interior wall of the hollow initial polymeric part, rotomolding the second added layer once the first polymer part has already been rotomolded or fabricated and achieving additional properties improvement of the composite part.

### BRIEF DESCRIPTION OF THE DRAWINGS

FIG. 1 shows a thermoplastic polymer hollow piece 1 with wall thickness that may be less than three millimeters and no more than few centimeters and any size and configuration limited by the preforming process;

FIG. 2 illustrates the metallic mold 2 of a roto-molding process containing the thermoplastic piece 1 within said mold, lip lock closure 3, clamping means 4, and pressure gas access 8.

FIG. 3 shows the polymeric piece 1 during the operation of fiber 7 hand laying up 6;

FIG. 4 illustrates robotic or automatic fiber tape laying up process 5.

FIG. 5 shows the polymer piece 1 comprising fibers 7 on to said piece surface;

FIG. 6 shows the piece 1 covered with fiber material 7, and the process step of disposing the piece to the interior of the mold; and also illustrates the clamping mechanism 4, vacuum hose attached to the mold wall 9 and pressure gas feed hose 8.

FIG. 7 shows the enclosed thermoplastic piece 1 within the mold 2 enclosing in between reinforcing fiber, all subjected to controlled pressure from the interior of the piece 1, fiber 7 and mold 2 through hose 8 and mold heating within an oven 10 and heating system

The process and composite materials product proposed in this invention incorporate a number of relevant advantages over to current commercial processes and produced composites.

### DETAILED DESCRIPTION OF THE INVENTION

The present invention is directed generally to fiber reinforced composite articles, and more particularly, to methods and apparatus for producing fiber reinforced composite articles.

The preferred embodiment of the present invention is directed to a method of producing a thermoplastic composite part or complex component thereof, comprising the steps of: laying one or a plurality of elements comprising reinforcing fibers cloth layers or any other reinforcing material fabric onto a surface of a hollow part of a thermoplastic polymeric material; said thermoplastic polymeric material having a prefabricated or preformed shape prepared within a metal mold by a roto-molding thermal process; using the roto-molding or shape mold, taking back and accommodating said part or component comprising the reinforced material surface layers to fit within said mold or initial shape interior; compressing a polymeric part wall and reinforcing fiber cloth against a mold wall inside the mold using pressurized gas from internal space of hollow piece, rising in parallel its temperature to obtain a viscoelastic condition or near melting condition of the polymer to achieve a compressed contact between the reinforcing fiber or pre-impregnated reinforcing fiber; creating a single material composite with a polymer piece comprising multi-ply layers integrated to the original polymeric resin by a fusion bonding and microfluidics mechanism between fiber cloth and polymer piece; conducting the production of thermoplastic composite material under pressure against the mold wall, temperature, viscoelastic condition and cooling rate control; optionally, laying fiber reinforcing material onto the interior surface of the mold to create an intimate contact and inter-diffusion between the thermoplastic polymeric part surface and the mold wall; and maintaining in a sandwich arrangement, the reinforced material cloth at viscoelastic temperature to form high properties thermoplastic composite material.

An alternate embodiment of the invention is directed to a method wherein the fiber cloth may be thermoplastic resin impregnated fiber cloth. Compress the polymer part and reinforcing fiber cloth against mold wall using pressurized gas from the internal space of the hollow piece, rising in parallel its temperature up to a level of viscus condition bellow melting temperature of the polymer, so as to achieve an intimate contact inter-diffusion in a microfluidic systems between the polymeric piece and resin impregnated fiber cloth or just fiber cloth, maintaining the reinforcing fiber cloth between metal mold and polymer piece to form a novelty high properties thermoplastic base composite material and method to fabricate the same.

Yet another alternate embodiment of the present invention is directed to a method of producing a thermoplastic composite material simple part or complex component thereof wherein it is possible to use any thermoforming process including press and vacuum thermoforming by incorporating the fiber on to the basic blank polymer initial sheet surface, allowing the thermo-diffusion of the basic thermoplastic resin through part or the total fiber thickness to conform the material composite and final shape of the part.

Yet another embodiment of the present invention is directed to a method of producing a thermoplastic composite simple part or complex component thereof wherein in order to produce the thermoplastic basic polymer preshape-reinforcing fiber composite material, it is possible to use any known thermal forming process, including roto-molding, injection molding, compression molding and autoclave prepreg layup process for which the mold can produce any shape.

Yet another embodiment of the present invention is directed to a method of producing a thermoplastic composite part or complex component thereof further comprising initially accommodating the reinforcing fiber cloth or laying up on to the mold internal surface while fabricated polymeric part, is taken back to be positioned and well fitted in the mold interior wall to form a sandwich arrangement conformed by the polymeric part; said reinforcing fiber cloth and the mold wall to form the thermoplastic composite material that comprises the polymeric part and the integrated reinforced fiber cloth for conforming the composite material part.

Yet another embodiment of the present invention is directed to a method of producing a thermoplastic composite part or complex component thereof, wherein the laying up reinforced fiber cloth comprises one or more layers of such reinforcing fabric or fiber to form the composite material.

Yet another embodiment of the present invention is directed to a method of producing a thermoplastic composite part or complex component thereof, further comprising wounding thermoplastic prepreg or not prepreg fiber tape over a previous polymer part or shape and locally applying heat and pressure at a contact point for melting and consolidation of the thermoplastic impregnated or not thermoplastic impregnated fiber tape over the whole part surface in a single step.

Yet another embodiment of the present invention is directed to a method of producing a thermoplastic composite part or complex component thereof wherein the compression of the layers comprising the composite material against the mold wall by a method comprising the pressure produced by pressurized gas inside the hollow piece to compress the layer or layers set against the mold wall.

Yet another embodiment of the present invention is directed to a method of producing a thermoplastic composite part or complex component thereof wherein, the composite material compression of reinforced fiber layers and polymer piece against the mold wall comprises method assisted by generating a low pressure atmosphere in a space formed between the polymeric piece and mold in order evacuate possible residual air or other gas bubbles gaps left trapped in this space, contained in the fiber cloth.

Yet another embodiment of the present invention is directed to a method of producing a thermoplastic composite part or complex component thereof comprising improving significant mechanical properties for the whole composite by eliminating discontinuities, air gaps or bubbles contained in said space under vacuum condition.

Yet another embodiment of the present invention is directed to a method of producing a thermoplastic composite part or complex component thereof, further comprising employing low pressure to evacuate and eliminate trapped gases in the reinforced fiber cloth space between mold wall and polymer piece wall.

Yet another embodiment of the present invention is directed to a method of producing a thermoplastic composite part or complex component thereof, further comprising conducting low pressure by the action of vacuum provided through ports properly located in the mold wall and distributed to achieve a uniform vacuum condition by the suction action in said space.

Yet another embodiment of the present invention is directed to a method of producing a thermoplastic composite part or complex component thereof, wherein during the compression of the composite material layers, further comprising transfer heat energy to the composite piece to rise its temperature up to its viscoelastic condition.

Yet another embodiment of the present invention is directed to a method of producing a thermoplastic composite part or complex component thereof, wherein the compression depends on the resin thermal characteristics in which the fiber is embedded and pre-shape piece polymer characteristics in order to achieve the proper consolidation in accordance to resin requirements.

Yet another embodiment of the present invention is directed to a method of producing a thermoplastic composite part or complex component thereof, wherein heating means is conducted from the exterior or from the interior heat source.

Yet another embodiment of the present invention is directed to a method of producing a thermoplastic composite part or complex component thereof, wherein pressure gas access port can be positioned in any location and position to meet the condition of supply uniform pressurized gas to the internal space of the mold.

Yet another embodiment of the present invention is directed to a method of producing a thermoplastic composite part or complex component thereof, wherein low pressure or vacuum produced in the space between polymer piece and metal mold, can be produced by external nozzles connected to vacuum hoses located on to external mold surface.

Yet another embodiment of the present invention is directed to a method of producing a thermoplastic composite part or complex component thereof, further comprising fabricating thermoplastic composite high pressure vessels.

Yet another embodiment of the present invention is directed to a method of producing a thermoplastic composite part or complex component thereof, optionally comprising additional laying up reinforcing fiber cloth on to the initial polymer piece, wrap high resistance polymer tape to the external surface of the polymer part to increase its hoop stress resistance.

Yet another embodiment of the present invention is directed to a method of producing a thermoplastic composite part or complex component thereof, wherein the polymer preformed part comprises reinforcing particulates or reinforcing fibers in order to increase the mechanical properties of such preshaped thermoplastic original part and therefore the properties of the whole composite fabricated part.

Yet another embodiment of the present invention is directed to a fiber reinforced thermoplastic composite part or complex component thereof wherein the heating of the composite part in process, can be transferred to the part located inside or outside the metal mold.

Yet another embodiment of the present invention is directed to a fiber reinforced thermoplastic composite part or complex component thereof prepared by the method of the present invention.

Other features, benefits and advantages of the present disclosure will become apparent from the following description of the disclosure, when viewed in accordance with the attached drawings.

The method of the present invention comprises the following relevant steps.

The rotomolding process equipment is used to produce a thermoplastic polymer piece and reinforcing fibers are layup on to said piece surface to then, a temperature and pressure consolidation process step is added, to produce the composite material parts comprising the preferred embodiment of the present invention, and producing a part with significantly enhanced properties and a better aesthetical appearance.

The proposed process and thermoplastic composite production provides a significant shorter cycle time compared to other composite fabrication processes and especially compared to thermoset composites cycled times. The amount of necessary added equipment is relatively small with low financial investment to produce material parts with excellent properties and lower running costs.

With respect to the composite material product characteristics, the following are important aspects in regard to enhanced properties and improved appearance. Although, in general the properties achieved by thermoplastic composites provide certain properties advantages over other composites such as thermoset matrix base composites, the proposed new composites provided by the present invention improve upon such advantages. The composites provided by the present invention possess higher fracture toughness, high impact resistance, high deformation capacity, high energy absorption, high impact strength, higher production rate, and low environmental impact. Associated with these properties is a significant increase in aspects of safety for certain applications, in which the fracture nature, open mode, speed and characteristic, becomes important in producing less damage derived from its energy absorption capacity.

Other advantages include higher flexibility in product range types, recyclability, good surface finish, long shelve storage periods, and highly aesthetical finishing and appearance design.

The present invention provides for production process lower costs and lower cycle times. The present strategy production advantages produce a composite part as a second stage of a conventional roto-molding production process, taking advantage of the installation, mold availability, low cost mold fabrication, and short cycle time.

The process of the present invention provides a greater range of composite product properties by varying and combining the different components of the composite material. For example, increasing the resilience properties of the basic polymer piece, the whole composite will increase its fracture toughness and thus providing high resilience composite components.

Other improved mechanical properties are obtained by different combinations of characteristics and dimensions of the polymer basic rotomolded piece and outer layers properties, like fiber orientation, number and specific weight of the fiber layers, or basic polymer piece thickness, or resin properties modification, or by adding to the polymer piece, reinforced charges of fibers or particulates, as for instance nano-particulates, certain oxides, graphene, and other particles of different length and type of reinforcing fibers to the basic polymer piece within the roto-molding processing.

The present invention comprises several process stages to manufacture thermoplastic composite components applicable to a range of industrial fabrication methods including those methods of fabrication of parts and components for aircraft, aerospace, automobiles, ships, pressure vessels, construction and civil engineering materials, electronic device elements, furniture and leisure furniture components, and sporting goods components.

A method of producing parts based on the the present invention comprises the following steps. A thermoplastic polymeric component is fabricated preferably by a rotomolding process. Rotomolding is a well known process that involves internal or external heat transfer to a hollow metal mold which is filled with a charge or shot weight of polymeric resin material. The mold is then heated and rotated in two axes causing a thermoplastic softened material to disperse and adhere to the internal walls of the mold maintaining even thickness of the polymeric resin material throughout the component. The rotation is maintained at all times during the heating phase and the cooling phase, thus avoiding deformation of the polymeric resin material during the cooling phase.

A method of the present invention comprises a first step comprising removing the thermoplastic polymer component when it is cool. The thermoplastic polymer component external surface comprises a basis upon which to lay up on one or more prepreg or non-prepreg reinforced fibers accommodated to provide a pile that covers part or the entire component, so that uniform and aesthetical roto-molded piece surface finish results.

This prepared component is transferred back to and fitted within the original mold in which the polymer component was initially fabricated, preferably by the known process of rotomolding, when the surface of the polymer piece is covered with reinforced fiber layer. When fitted inside the mold and mechanically locked by the clamping, the mold is subjected to internal pressure and heated to the softening bellow melting temperature of the polymeric piece material.

The thermoplastic and fiber reach an intimate interface contact, in such viscoelastic condition of pressure and temperature, consolidated in a single stage, with no necessity of a long curing period, as is required for the case of thermosetting materials. The present invention comprises a composite ply layer or layers consolidation stage providing intimate contact between the ply layers and the polymeric rotomolded part original material component. The result is a material composite comprising one or multi-ply layers integrated to the original polymeric resin piece by a fusion bonding mechanism. The mold wall creates pressure on the resulting material and generates an interdiffusion and a microfluidic system condition under pressure, temperature, viscoelastic condition and cooling rate control, and thus the production of a remarkable properties thermoplastic composite material.

The step of consolidation includes selection of resin added (with prepreg or externally) melting and curing temperatures that are defined and selected according to the base polymer part process temperatures, so as to keep the reinforcing layers process temperatures in accordance to the base polymer part characteristics within certain temperatures.

Remarkable properties are achieved by carrying out the above described process using adequate high properties polymeric components providing consistency between the pre-shaped part polymer characteristics and reinforcing fiber impregnation or added polymer resin properties. In the present invention's innovative process, pressure from the internal space is enhanced by providing several vacuum ports disposed on the exterior of the mold, connecting an external hose vacuum system to the interior mold wall. Suction produced by the vacuum ports enhances the pressure and contributes to migration and elimination of gas trapped within the composite, specifically in the case of prepreg fiber resin fabric space.

In the previously described process, mold heat input and cooling control is important to determine the final properties and degree of crystallinity in certain polymers, including for instance PEEK. In a last step of the method of the present invention, once the piece cools, itis removed from the mold.

The reinforced fibers containing resins comprising the thermoplastic composite include thermoplastic prepreg layer or layers that are comprising different fibers including glass, carbon, aramid, and as a matrix, other various resins such as polyetheretherketone (PEEK), polyphenylene sulfide (PPS), polyamide, polyetherimide (PEI), polypropylene (PP), and polymethylmethacrylate (PMMA, (PES) Poly-ethersulphone.

Common prepregs used include carbon fiber disposed in polyetheretherketone, carbon fiber disposed in nylon and carbon fiber disposed in polypropylene as well as those described previously. The present invention comprises other resins depending on the final application of the component. These applications include structural oriented use, in which high strength and toughness polymeric resins are used, or for non-structural final use oriented to decorative parts or leisure objects in which a thinner thickness, soft flexible polymer is processed in the same method. An enormous range of possible surface textures and hardness/softness or deformation/stiffness properties; for instance, can be used in special furniture components.

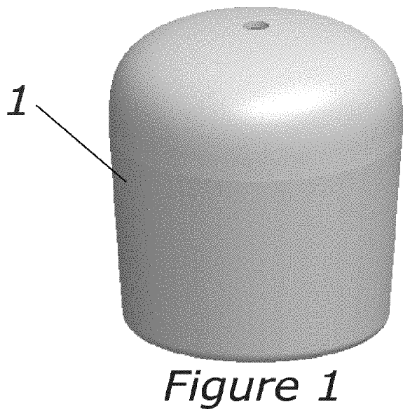

FIG. 1 shows a thermoplastic polymer hollow piece 1 with wall thickness that might be less than three millimeters and no more than two centimeters and any size and configuration limited by the preforming process.

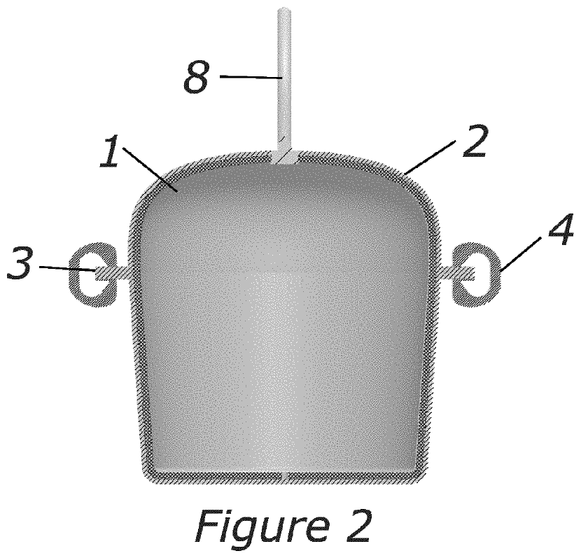

FIG. 2 illustrates metal mold 2 comprising a thermoplastic polymeric material piece 1 fabricated via a thermally forming process within metallic mold 2 preferable by a roto-molding process. The mold opens and closes by an opening and seal flange or lip 3 through which the component is allowed to be demolded or removed from its mold. The component is also enclosed and held by pressure gripping hold element 4. Element 4 also holds the mold parts within which polymeric material is thermal processed.

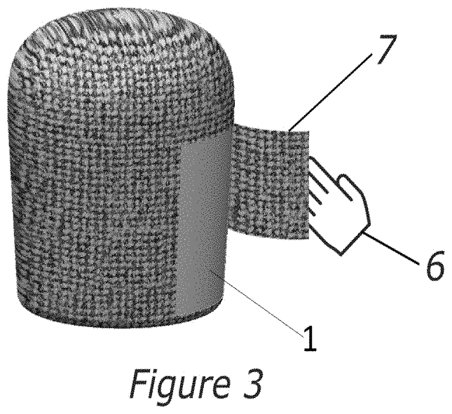

FIG. 3 illustrates the polymeric piece during the operation of laying up of reinforcing fiber cloth 7 hand lay up 6 locating on to the component surface. One or more layers of the fiber material can be or not impregnated with a suitable thermoplastic resin.

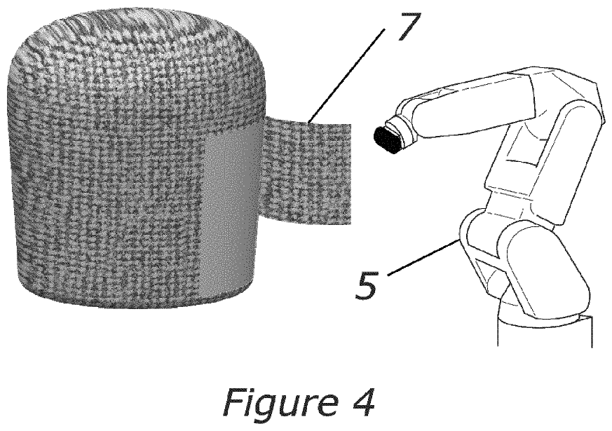

FIG. 4 illustrates tape automatic application 5 of thermoplastic reinforcing fiber cloth 7.

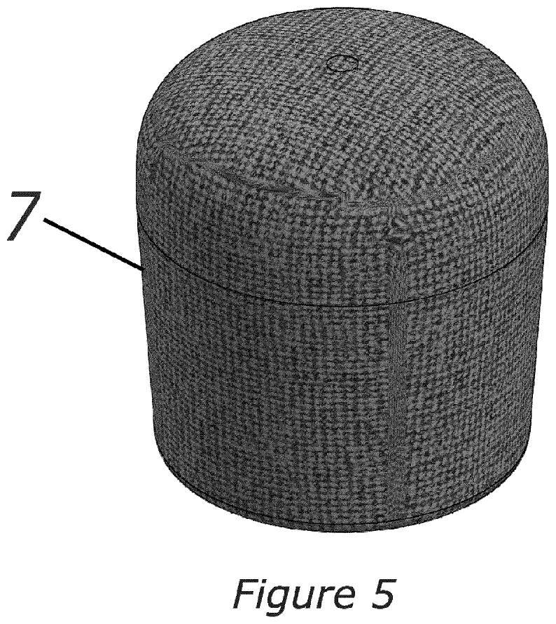

FIG. 5 illustrates the component with the necessary or calculated layers of reinforcing fibers 7 containing or integrated onto its surface.

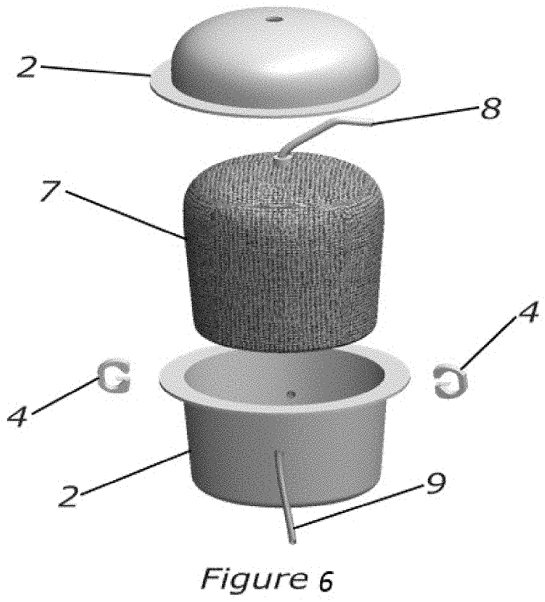

FIG. 6 illustrates the polymeric component covered with the fiber cloth 7 incorporating nozzle and hose 8 through which air or other gases are injected into the interior of the hollow component. Also illustrates the process step of disposing the previously prepared polymer component having fiber layers 7 to the interior of mold 2. The internal pressure of the piece is raised to within 0.1 and 20 atm once this is fit inside the mold which is tightly locked to contain and maintain the internal pressure in the piece disposed within the mold pushing the piece wall against the mold wall.

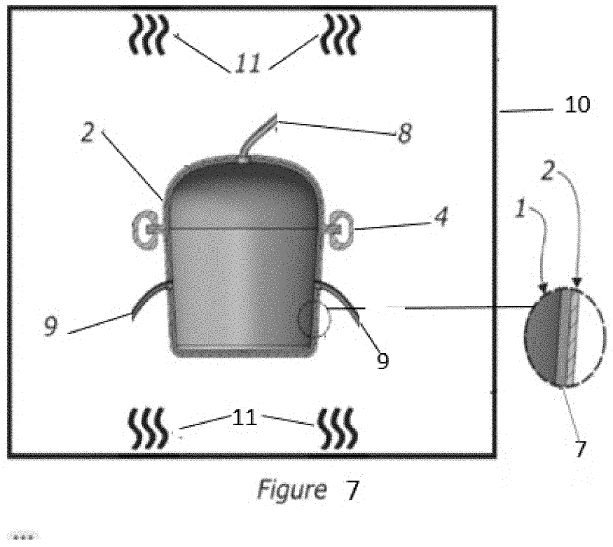

FIG. 7 illustrates the enclosed component within the mold subjected to pressure through nozzles 8 and heating element 11 within a heating enclosure oven 10.

The method of the present invention comprises a step in which the resin contained in the fiber is cured by the effect of temperature rise and the polymeric component can be, according to the resin characteristics, consolidated by the effect of temperature and pressure from the inside of the hollow mold. The component wall is compressed and the fiber layers may be impregnated against the metal mold internal wall. It is important to notice that the gas compression from the interior of the hermetic piece causes such piece to expand, pushing the polymer piece wall to the metal mold wall, but at the same time, just the heating of the polymer piece provokes its thermal expansion and thus compression of its wall against the metal mold wall, only because of the thermal expansion difference between polymeric material and metal, as if it were a natural process sequence.

This method provides a condition that softens the fiber containing resin and thermoplastic piece resin and then cools in a controlled way to reach desired final properties. In the consolidation process, the fiber containing the resin layers is compressed to the wall of the polymeric component, disposed in close contact to conform by resin bonding, a novel single or multi-layer thermoplastic composite material with improved properties.

As the fiber, resin contained or impregnated in it, and the polymeric wall piece consolidate within the heating and cooling process under pressure, a novel material is formed.

The present invention comprises a unique method using a unique apparatus to provide a new composite material; the material comprising unique properties compared with other similar composite material. The unique properties include high resilience, high energy absorption deformation capacity, higher toughness, high impact strength, higher production rate, low environmental impact, lower investment and running costs, higher flexibility in product range types, is totally recyclable, good surface finish, among others like long shelve storage periods as is the case of thermoplastic materials and prepregs.

### PREFERRED EMBODIMENT OF THE INVENTION

The preferred context and use of the process and product presented in this invention is associated and applied to the process and products of rotomolding process, from which a rotomolded polymer part is fabricated and demolded to then according to this invention, a layer or layers of reinforcing fiber material, including fabrics of different fibers are lay up or by automatic means, rap fiber tape or prepreg tape, or filament winding on to said part external surface which for this preferred embodiment is hollow and normally configured as closed container or vessel. Once covered by said reinforced fibers and mechanisms, take said piece back to the mold and once well fitted within said mold, rise the temperature and pressure in the mold, preferable in rotation to maintain a uniform thickness of the polymeric piece. Once the polymer piece is soft and under pressure contact with the fiber, cool down, preferably in rotation, is used to achieve a uniform temperature distribution of the piece during cooling down stage. An alternate embodiment or process context is the use of a thermoforming process, in which the fiber is also integrated to the thermoplastic preshape and then thermoformed comprising the two elements during such thermal processing.

### EXAMPLES

### Thermoplastic Composite Cases

Two cases are described: 1. to lay up the polymer piece external surface with dry fabric or direct fiber; and 2. to lay up the polymer piece external surface with thermoplastic prepreg fiber fabric. The external surface polymer piece is covered with fiber cloth and then returned to the mold and submitted to pressure in the range from 0.1 to 20 atm. and temperature in the range of 60° to 300° C. These temperatures and pressures are in accordance with the softening characteristics of the polymer of the piece, and the complete fiber fabric or layers of fiber fabric is integrated to the bulk of the polymer component.

The temperature and pressure within these ranges against the cloth fibers provide a microfluidic system which is developed in accordance with the rheology of the softened polymer. In a second case, the polymer piece flow was integrated to part of the fibers and formed an intra layer fiber/polymer, so part of the fiber was integrated to the polymer and the rest remained available to interact with other external agents that might determine a range of added properties, depending on the agent's characteristics.

The above mentioned cases principle can apply to other processes contexts to produce the same result, so the present invention is embodied in other specific forms without deviating from the characteristics of the above invention. The described embodiments are to be considered in all respects only as illustrative and not restrictive. The scope of the invention is therefore indicated by the appended claims rather than by the foregoing description. All changes which come within the meaning and range of equivalency of the claims are to be embraced within their scope.

It is claimed:

1. A method of producing a fiber reinforced thermoplastic composite part or complex component thereof, comprising the steps of:
laying one or a plurality of elements comprising reinforcing fibers cloth layers or any other reinforcing material fabric onto a surface of a hollow or not hollow part of a thermoplastic polymeric material wherein the thermoplastic polymeric material preferably comprising a prefabricated or preformed shape preferably prepared within a mold by a roto-molding thermal process;
using the roto-molding or shape mold, taking back and accommodating the part or component comprising the reinforced material surface layers to fit within the mold or initial forming shape interior;
compressing a polymeric part wall and reinforcing fiber cloth against a mold wall inside the mold using pressurized gas from the internal space of hollow piece, rising in parallel its temperature to obtain a viscoelastic condition or near melting condition of the polymer to achieve a compressed contact between the reinforcing fiber or pre-impregnated reinforcing fiber;
creating a single monolithic material composite with a thermoplastic polymer piece and comprising multi-ply layers integrated to the original polymeric resin by a fusion bonding and microfluidics mechanism between fiber cloth and polymer piece;
conducting the production of thermoplastic composite material under pressure against the mold wall controlling temperature, viscoelastic condition and cooling rate;
optionally, laying fiber reinforcing material onto the interior surface of the mold to create an intimate contact and inter-diffusion between the thermoplastic polymeric part surface and the mold wall; and
maintaining in a sandwich arrangement, the reinforced material cloth at viscoelastic temperature to form high properties thermoplastic composite material.

2. The method of claim 1 wherein the reinforcing fiber is selected from a group including but not limited to a thermoplastic polymer fabric impregnated or not impregnated or any reinforcing resin pre-impregnated fiber (prepreg fiber).

3. The method of claim 1 wherein producing the process for preparing thermoplastic basic polymer preshape-reinforcing fiber composite material comprises a thermal forming process, roto-molding, injection molding, compression molding and an autoclave prepreg layup process wherein the mold produces any shape.

4. The method of claim 1 further comprising the steps:
initially accommodating the reinforcing fiber cloth or laying up on to the mold internal surface;
taking the fabricated polymeric part and positioning and fitting it in the mold interior wall; and
forming a sandwich arrangement conformed by the polymeric part wherein the reinforcing fiber cloth and the mold wall forms the thermoplastic composite material that comprises the polymeric part and the integrated reinforced fiber cloth for conforming the composite material part.

5. The method of claim 1 wherein the laying up reinforced fiber cloth comprises one or more layers of the reinforcing fabric or fiber forms the composite material.

6. The method of claim 1, further comprising the steps:
winding thermoplastic prepreg or not prepreg tape over a previous polymer part or shape;
locally applying heat and pressure at a contact point; and
melting and consolidating the thermoplastic tape over the entire surface of the part in a single step.

7. The method of claim 1 wherein the compression of the layers comprising the composite material against the mold wall occurs by a method comprising the pressure produced by pressurized gas inside the hollow piece to compress the piece wall and layer or layers set against the mold wall.

8. The method of claim 1, wherein the composite material compression of reinforced fiber layers and polymer piece against the mold wall comprises method assisted by generating a low pressure atmosphere in a space formed between the polymeric piece and mold in order evacuate possible residual air or other gas bubbles gaps left trapped in this space, contained in the fiber cloth.

9. The method of claim 1 comprising improving significant mechanical properties for the whole composite by eliminating discontinuities, air gaps, or bubbles contained in the space under vacuum condition.

10. The method of claim 1 further comprising employing low pressure to evacuate and eliminate trapped gases in the reinforced fiber cloth space between mold wall and the polymer piece wall.

11. The method of claim 1 further comprising conducting low pressure by the action of vacuum provided through ports disposed in the mold wall and distributed to achieve a uniform vacuum condition by the suction action in the space.

12. A method of compressing the composite material layers wherein heat energy is transferred to the composite piece to raise its temperature up to the piece's viscoelastic condition.

13. The method of claim 12 wherein the compression depends on the resin thermal characteristics in which the fiber is embedded and pre-shape piece polymer characteristics in order to achieve the proper consolidation in accordance to resin requirements.

14. The method of claim 13 wherein heating is conducted from the exterior or from the interior of the piece or mold by a heat source.

15. The method of claim 1 wherein the pressure gas access port is positioned in any location and position to supply uniform pressurized gas to the internal space of the mold.

16. The method of claim 1 wherein low pressure or vacuum produced in the space between polymer piece and metal mold is produced by external nozzles connected to vacuum hoses disposed on the external mold surface.

17. The method of claim 1 further comprising fabricating thermoplastic composite high pressure vessels.

18. The method of claim 1 further comprising laying up additional reinforcing fiber cloth on to the initial polymer piece and wrapping high resistance polymer tape to the external surface of the polymer part.

19. The method of claim 1 wherein the polymer preformed part comprises reinforcing particulates or reinforcing fibers in order to increase the mechanical properties of such preshaped original part and therefore the properties of the whole composite fabricated part.

20. The method of claim 1 further comprising:
incorporating an internal layer of a second reinforced polymer as an added layer on to the surface of the interior wall of the hollow initial polymeric part;
rotomolding the second added layer once the first polymer part has already been rotomolded or fabricated; and
achieving additional properties improvement of the composite part.
